(19) United States
(12) Patent Application Publication
(10) Pub. No.: US 2017/0024788 A1
(43) Pub. Date: Jan. 26, 2017

(54) Transaction Proposal Generator

(71) Applicant: Disney Enterprises, Inc., Burbank, CA (US)

(72) Inventors: Thomas W. Denslow, III, Winter Garden, FL (US); Ludwig C. Kuznia, Lakeland, FL (US); Kevin S. Hill, Orlando, FL (US); Steven W. Whittington, Orlando, FL (US); Haining Yu, Windermere, FL (US); Jingyang Xu, Orlando, FL (US)

(73) Assignee: Disney Enterprises, Inc.

(21) Appl. No.: 14/804,949

(22) Filed: Jul. 21, 2015

(51) Int. Cl. G06Q 30/06; G06Q 30/02

(52) U.S. Cl. CPC G06Q 30/0611; G06Q 30/0272

(57) ABSTRACT

There are provided transaction proposal generation systems and methods. Such a system includes a hardware processor, a system memory, and a transaction proposal unit including a consumer-to-product matching module and a transaction analysis module stored in the system memory. The hardware processor is configured to execute the transaction proposal unit to receive a first data corresponding to a transactional history of each of several market participants, receive a second data corresponding to a demand, by each market participant, for each of a number of products, and transform the first data and the second data into a third data identifying a prospective consumer for at least one of the products. The transaction proposal unit can be further executed to determine terms for a transaction including the prospective consumer and the product(s), and generate a transaction proposal identifying the prospective consumer, the product(s), and the terms.

### BACKGROUND

End-users of media content, such as viewers of television (TV) or movie content, gamers, and those who enjoy listening to music content, for example, have increasingly more options for how to consume such media content than ever before. For instance, viewers of TV or movie content can now not only select the particular program or movie they wish to view, but can also control the transmission mode for delivery of that content and the entertainment platform on which the content is viewed, as well as the timing and duration of the viewing experience. One consequence of this evolving media consumption environment is that advertisers have increasing opportunities to go beyond traditional age and gender distinctions to target potential purchasers for their goods or services. As a result, producers and publishers of media content must strengthen their transactional relationships with such advertisers by demonstrating that the content they offer provides an effective vehicle for marketing those goods or services.

### SUMMARY

There are provided systems and methods for transaction proposal generation, substantially as shown in and/or described in connection with at least one of the figures, and as set forth more completely in the claims.

### BRIEF DESCRIPTION OF THE DRAWINGS

FIG. 1 shows a diagram of an exemplary transaction proposal generation system, according to one implementation of the present disclosure;

FIG. 2 shows another exemplary implementation of a transaction proposal generation system, according to one implementation of the present disclosure;

FIG. 3 shows an exemplary system and a computer-readable non-transitory medium including instructions for transaction proposal generation, according to one implementation of the present disclosure; and

FIG. 4 is a flowchart presenting an exemplary method for use by a transaction proposal generation system, according to one implementation of the present disclosure.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application addresses the advertising challenges described above, as well as analogous marketplace dilemmas, by providing transaction proposal generation systems and methods. According to one implementation, such a system and method may be used to assist producers and/or publishers of media content in demonstrating to advertisers that the content those producers and/or publishers offer provides an effective vehicle for marketing the advertisers' goods or services.

As disclosed in the present application, a transaction proposal generation system includes a transaction proposal unit having a consumer-to-product matching module configured to identify a prospective consumer for one or more available products. The transaction proposal unit also includes a transaction analysis module configured to determine terms for a transaction including the prospective consumer and the one or more products. The transaction proposal unit is further configured to generate a transaction proposal identifying the prospective consumer, the one or more products, and the terms. In addition, in one implementation, the transaction proposal unit can identify a score for the transaction being proposed that corresponds to a likelihood of acceptance of the transaction proposal by the prospective consumer.

In other words, the transaction proposal generation systems and methods disclosed in the present application can provide a comprehensive tool for searching out, evaluating, proposing, and implementing transactions between the producers or suppliers of a product and consumers of such products. Moreover, the transaction proposal generation systems and methods disclosed in the present application can be configured to identify and propose transactions capable of conferring substantial benefits to product producers or suppliers and consumers alike.

The transaction proposal generation provided by the systems and according to the methods disclosed in the present application can be applied across a wide variety of product markets and across a diverse population of potential consumers. For example, as discussed above, in some implementations, such “consumers” may be advertisers seeking marketing opportunities for their offered goods or services. Moreover, in those implementations, the one or more products subject to consumer-to-product matching according to the present systems and methods may include advertising time during an entertainment presentation, such as advertising time in a TV programming stream. Thus, as used in the present application, the term “product” may refer to a good, a service, an opportunity, such as an advertising opportunity, or any other tangible or intangible thing for which a market can exist.

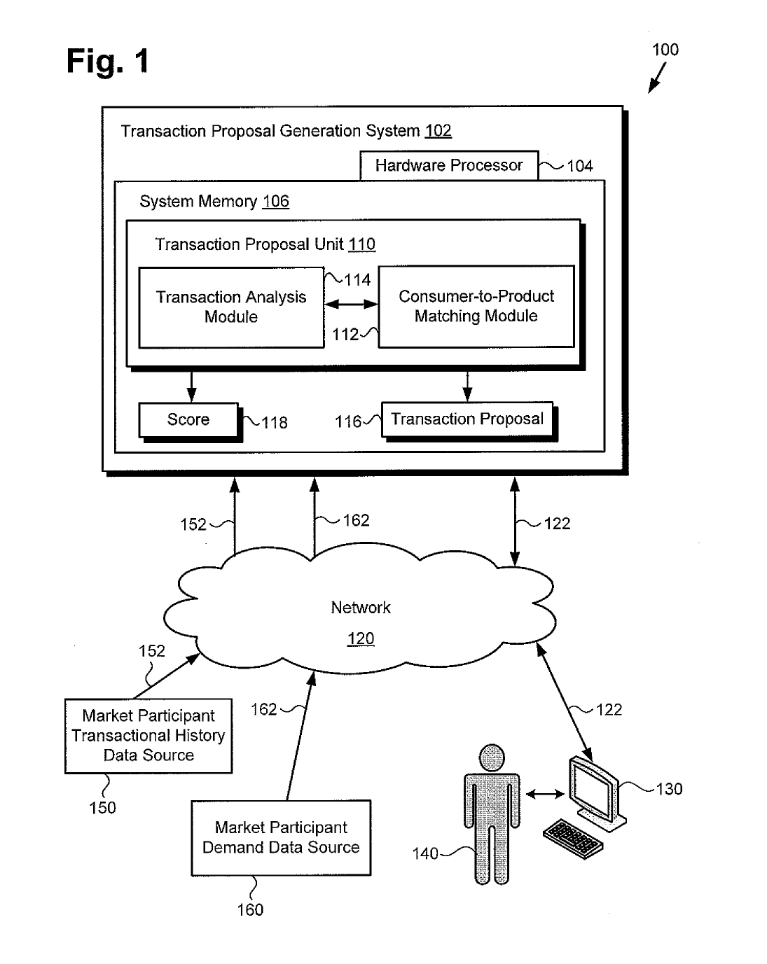

FIG. 1 shows a diagram of an exemplary transaction proposal generation system, according to one implementation. As shown in FIG. 1, transaction proposal generation system 102 is situated within transaction proposal generation environment 100 including communication network 120, client system 130, system user 140, market participant transactional history data source 150, and market participant demand data source 160.

Transaction proposal generation system 102 includes hardware processor 104, and system memory 106 storing transaction proposal unit 110 including consumer-to-product matching module 112 and transaction analysis module 114. In addition, system memory 106 is shown to include transaction proposal 116 and score 118 produced using transaction proposal unit 110. Also shown in FIG. 1 are network communication links 122 interactively connecting client system 130 and transaction proposal generation system 102 via communication network 120, as well as data 152 and data 162 received by transaction proposal generation system 102 via communication network 120.

According to the implementation shown in FIG. 1, system user 140 may utilize client system 130 to interact with transaction proposal generation system 102 over communication network 120, for example to access transaction proposal unit 110 remotely or to download transaction proposal unit 110 to client system 130. In one such implementation, transaction proposal generation system 102 may correspond to one or more web servers, accessible over a packet network such as the Internet, for example. Alternatively, transaction proposal generation system 102 may correspond to one or more servers supporting a local area network (LAN), or included in another type of limited distribution network.

Hardware processor 104 is configured to execute transaction proposal unit 110 to receive data 152 corresponding to a transactional history of each of several market participants in a market. Hardware processor 104 is further configured to execute transaction proposal unit 110 to receive data 162 corresponding to a demand, by each of the several market participants, for each of a number of products on the market. Hardware processor 104 is also configured to execute transaction proposal unit 110 to use consumer-to-product matching module 112 to transform data 152 and data 162 into another data identifying a prospective consumer for one or more of the number of products, from among the several market participants. In addition, hardware processor 104 is configured to execute transaction proposal unit 110 to use transaction analysis module 114 to determine terms for a transaction including the prospective consumer and the one or more products. Moreover, hardware processor 104 is configured to execute transaction proposal unit 110 to generate transaction proposal 116 identifying the prospective consumer, the one or more products, and the terms.

It is noted that, in some implementations, the transaction proposed by transaction proposal 116 may include purchase of the one or more products by the prospective consumer. However, in other implementations, a transaction other than a purchase may be proposed. For example, transaction proposal 116 may include a leasing proposal, a rental proposal, or a licensing proposal, among other possibilities. Furthermore, and as noted above, the one or more products included in transaction proposal 116 may include advertising time during an entertainment presentation. As a specific example, the one or more products included in transaction proposal 116 may include advertising time in a TV programming stream.

In some implementations, hardware processor 104 is configured to execute transaction proposal unit 110 to display transaction proposal 116 to system user 140. Moreover, in some implementations, hardware processor 104 is configured to execute transaction proposal unit 110 to receive, for example via network communications links 122, an input from system user 140 modifying one or more of the prospective consumer, the one or more products, and the terms. In those implementations, hardware processor 104 is configured to execute transaction proposal unit 110 to generate another transaction proposal based on the input from system user 140.

In addition, in some implementations, hardware processor 104 may be configured to execute transaction proposal unit 110 to identify score 118 corresponding to a likelihood of acceptance of transaction proposal 116 by the prospective consumer. Score 118 may be stored in system memory 106 and/or may be reported to system user 140, for example.

It is noted that although FIG. 1 depicts transaction proposal 116 and score 118 as residing in system memory 106, in some implementations, transaction proposal 116 and/or score 118 may be copied to non-volatile storage (not shown in FIG. 1), or may be transmitted to client system 130 via communication network 120. It is further noted that although client system 130 is shown as a personal computer (PC) in FIG. 1, that representation is provided merely as an example. In other implementations, client system 130 may be another type of personal communication device, such as a smartphone or tablet computer, for example.

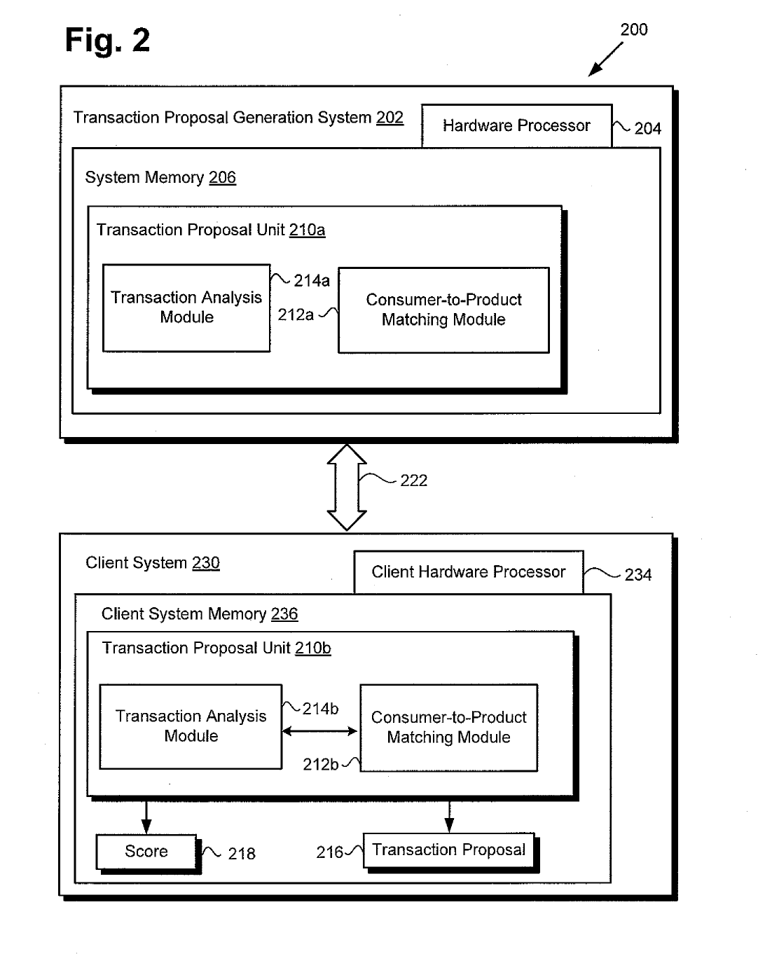

Referring to FIG. 2, FIG. 2 shows a more detailed exemplary implementation of client system 230, which may itself be configured to perform transaction proposal generation. Transaction proposal generation environment 200 in FIG. 2 includes client system 230 interactively connected to transaction proposal generation system 202 over network communication link 222. As shown in FIG. 2, transaction proposal generation system 202 includes hardware processor 204, and system memory 206 storing transaction proposal unit 210a including consumer-to-product matching module 212a and transaction analysis module 214a. As further shown in FIG. 2, client system 230 includes client hardware processor 234, and client system memory 236 storing transaction proposal unit 210b including consumer-to-product matching module 212b and transaction analysis module 214b. Also shown in FIG. 2 are transaction proposal 216 and score 218 produced by transaction proposal unit 210b on client system 230.

Network communication link 222, and transaction proposal generation system 202 including hardware processor 204 and system memory 206 correspond in general to network communication link 122, and transaction proposal generation system 102 including hardware processor 104 and system memory 106, in FIG. 1. In addition, transaction proposal unit 210a including consumer-to-product matching module 212a and transaction analysis module 214a, in FIG. 2, corresponds to transaction proposal unit 110 including consumer-to-product matching module 112 and transaction analysis module 114, in FIG. 1. In other words, transaction proposal unit 210a, consumer-to-product matching module 212a, and transaction analysis module 214a may share any of the characteristics attributed to corresponding transaction proposal unit 110, consumer-to-product matching module 112, and transaction analysis module 114 shown in FIG. 1 and described above.

Client system 230 corresponds in general to client system 130, in FIG. 1. Moreover, transaction proposal unit 210b including consumer-to-product matching module 212b and transaction analysis module 214b corresponds to transaction proposal unit 110/210b including consumer-to-product matching module 112/212b and transaction analysis module 114/214b. As a result, transaction proposal unit 210b, consumer-to-product matching module 212b, and transaction analysis module 214b may share any of the characteristics attributed to corresponding transaction proposal unit 110, consumer-to-product matching module 112, and transaction analysis module 114 shown in FIG. 1 and described above.

According to the exemplary implementation shown in FIG. 2, transaction proposal unit 210b including consumer-to-product matching module 212b and transaction analysis module 214b is located in client system memory 236, having been received from transaction proposal generation system 202 via network communication link 222. In one implementation, network communication link 222 corresponds to transfer of transaction proposal unit 210b including consumer-to-product matching module 212b and transaction analysis module 214b over a packet network, for example. Once transferred, for instance by being downloaded over network communication link 222, transaction proposal unit 210b including consumer-to-product matching module 212b and transaction analysis module 214b may be persistently stored in client system memory 236 and may be executed locally on client system 230 by client hardware processor 234.

Client hardware processor 234 may be the central processing unit (CPU) for client system 230, for example, in which role client hardware processor 234 runs the operating system for client system 230 and executes transaction proposal unit 210b. In the exemplary implementation of FIG. 2, a user of client system 230, such as system user 140, in FIG. 1, can utilize transaction proposal unit 210b on client system 230 to generate transaction proposal 216 and/or to identify score 218, which correspond respectively to transaction proposal 116 and score 118.

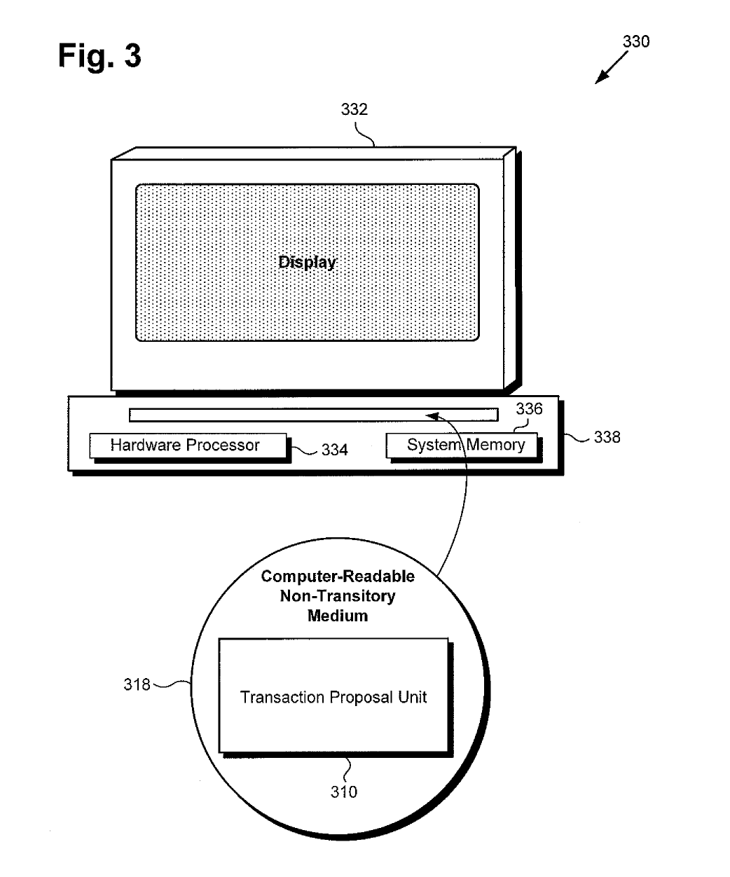

Moving now to FIG. 3, FIG. 3 shows an exemplary system and a computer-readable non-transitory medium including instructions enabling transaction proposal generation, according to one implementation. System 330 includes computer 338 having hardware processor 334 and system memory 336, interactively linked to display 332. Display 332 may take the form of a liquid crystal display (LCD), a light-emitting diode (LED) display, an organic light-emitting diode (OLED) display, or another suitable display screen that performs a physical transformation of signals to light. System 330 including hardware processor 334 and system memory 336 corresponds in general to any or all of transaction proposal generation system 102 and client system 130, in FIG. 1, and transaction proposal generation system 202 and client system 230, in FIG. 2.

Also shown in FIG. 3 is computer-readable non-transitory medium 318 having transaction proposal unit 310 stored thereon. The expression “computer-readable non-transitory medium,” as used in the present application, refers to any medium, excluding a carrier wave or other transitory signal, that provides instructions to hardware processor 334 of computer 338. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

According to the implementation shown in FIG. 3, computer-readable non-transitory medium 318 provides transaction proposal unit 310 for execution by hardware processor 334 of computer 338. Transaction proposal unit 310, when executed by hardware processor 334, instantiates a transaction proposal unit corresponding to transaction proposal unit 110/210a/210b, in FIG. 1/2, and capable of performing all of the operations attributed to those corresponding features by the present disclosure.

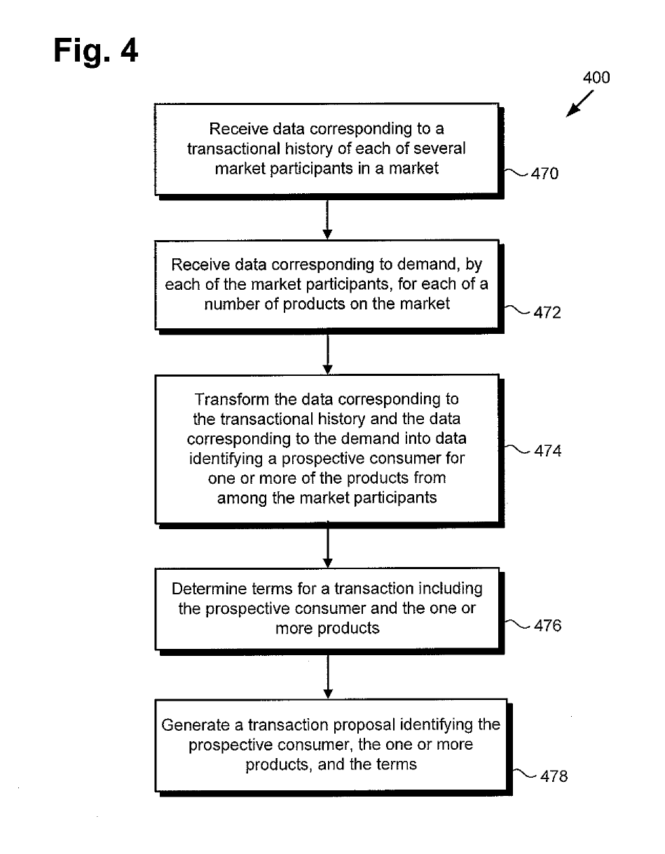

The systems suitable for use as transaction proposal generation systems and discussed above by reference to FIGS. 1, 2, and 3, will be further described below with reference to FIG. 4. FIG. 4 presents flowchart 400 outlining an exemplary method for use by a transaction proposal generation system.

Flowchart 400 begins with receiving data 152 corresponding to a transactional history of each of several market participants in a market (action 470). Data 152 may be received by transaction proposal unit 110/210a/210b/310 of system 102/202/230/330, executed by respective hardware processor 104/204/234/334. As shown in FIG. 1, data 152 may be received by transaction proposal unit 110/210a/210b/310 from market participant transactional history data source 150, via communication network 120.

By way of example, where the several market participants are advertisers, and the market is a market for advertising time during TV programming, data 152 may be received from market participant transactional history data source 150 in the form of a third party aggregator of TV advertising metrics, such as Nielsen™ or iSpot.tv™, among others. Moreover, in such an exemplary use case, data 152 may correspond to the percentage of a particular advertiser's ad budget that is presently being or has been spent on a particular genre of TV programming content. For example, assuming a marketplace for TV advertising time and three advertisers acting as market participants, i.e., advertiser A, advertiser B, and advertiser C, data 152 might report what percentage of each advertiser's ad budget is spent on each of reality based programming, law enforcement themed dramas, and science themed sitcoms.

Flowchart 400 continues with receiving data 162 corresponding to demand, by each of the several market participants, for each of a number of products on the market (action 472). Data 162 may be received by transaction proposal unit 110/210a/210b/310 of system 102/202/230/330, executed by respective hardware processor 104/204/234/334. As shown in FIG. 1, data 162 may be received by transaction proposal unit 110/210a/210b/310 from market participant demand data source 160, via communication network 120.

Continuing with the exemplary TV advertising use case scenario introduced above, data 162 may be received from a media content producer or publisher (hereinafter “content provider D”), and may be provided from the advertising sales statistics aggregated internally by content provider D. For example, where content provider D is a TV network providing each of reality based programming, law enforcement themed dramas, and science themed sitcoms, data 162 may correspond to the percentage of the advertising budget received by content provider D from each of advertisers A, B, and C that is earmarked for each of the respective TV programming genres.

The present exemplary TV advertising use case scenario is being described in terms of few variables and very little complexity so as not to obscure the inventive concepts disclosed by the present application. It is noted, however, that in practice, data 152 and data 162 would typically be much richer than heretofore characterized. That is to say, data 152 and data 162 may contain substantially more information than simply TV programming genre and percentage of dedicated ad budget earmarked for each genre. For example, data 152 may correspond to the transactional history of each of advertisers A, B, and C relative to each of reality based programming, law enforcement themed dramas, and science themed sitcoms when correlated with one or more additional variables. Such additional variables may include, for example, mode of broadcast or transmission of the programming, the time of day or season of the year during which the programming is available, or variations in advertising activity by time zone and/or geographic region. Moreover, data 162 may correspond to the demand by each of advertisers A, B, and C for each of reality based programming, law enforcement themed dramas, and science themed sitcoms available from content provider D, when also correlated with one or more additional variables, which may be substantially the same variables used in data 152, or may include other variables.

Flowchart 400 continues with transforming data 152 and data 162 into a third data identifying a prospective consumer for one or more of the products from among the several market participants (action 474). The transformation of data 152 and data 162 can be performed by transaction proposal unit 110/210a/210b/310 of system 102/202/230/330, executed by respective hardware processor 104/204/234/334, and using consumer-to-product matching module 112/212a/212b.

For example, where data 152 and data 162 are substantially inconsistent, the likelihood that a mutually beneficial transaction can be proposed may be identified. As a specific example, where data 152 identifies advertiser A as spending forty percent (40%) of its ad budget on law enforcement themed dramas, but data 162 reveals that only 15% of the budget allocated to content provider D by advertiser A is earmarked for that programming genre, a potential transaction may be identified. That is to say, data 152 and data 162 may be transformed into data identifying advertiser A as a prospective consumer for advertising time during law enforcement themed dramas presented by content provider D.

Flowchart 400 continues with determining terms for a transaction including the prospective consumer and the one or more products (action 476). Determination of terms for the transaction can be performed by transaction proposal unit 110/210a/210b/310 of system 102/202/230/330, executed by respective hardware processor 104/204/234/334, and using transaction analysis module 114/214a/214b.

Continuing with the example use case scenario discussed in some detail above, transaction analysis module 114/214a/214b may be utilized to determine terms for a transaction resulting in the amount of money spent by advertiser A on advertising during law enforcement themed dramas available from content provider D being increased. Such terms may be determined so as to substantially optimize the benefit to the prospective consumer, i.e., advertiser A, to substantially optimize the benefit to the media content producer or publisher, i.e., content provider D, or to substantially optimize the likelihood of acceptance of the transaction by the prospective consumer.

For example, based on the under purchasing by advertiser A of advertising time during law enforcement themed dramas presented by content provider D relative to the transactional history of advertiser A in the market, the transaction terms determined using transaction analysis module 114/214a/214b may serve to better align those metrics. In some instances, those transaction terms may include an increase in the total spending of advertiser A on programming presented by content provider D due to an increase in spending on law enforcement themed dramas. However, in other instances, the transaction terms may include a rebalancing of the ad budget allocated by advertiser A to content provider D in order to increase the percentage of the ad budget earmarked for law enforcement themed dramas without increasing ad budget spending by advertiser A in absolute terms. Moreover, it is noted that although the present specific example describes the sale and purchase of advertising time during TV programming, in other implementations, the present inventive principles can be applied to transactions including the rental, lease, or licensing of a wide variety of products.

Flowchart 400 continues with generating transaction proposal 116/216 identifying the prospective consumer, the one or more products, and the transaction terms (action 478). Generation of transaction proposal 116/216 may be performed by transaction proposal unit 110/210a/210b/310 of system 102/202/230/330, executed by respective hardware processor 104/204/234/334.

In some implementations, flowchart 400 may conclude with generation of transaction proposal 116/216. However, in other implementations, the method of flowchart 400 may continue with displaying transaction proposal 116/216 to system user 140. Moreover, in some implementations, a transaction proposal generation system corresponding to systems 102/202/230/330 may be configured to enable system user 140 to modify transaction proposal 116/216. In those implementations, the method of flowchart 400 may further include receiving an input from system user 140 modifying one or more of the prospective consumer, the one or more products, and the terms included in transaction proposal 116/216, and generating another transaction proposal based on that input. Receiving the input and generating another transaction proposal may be performed by transaction proposal unit 110/210a/210b/310 of system 102/202/230/330, executed by respective hardware processor 104/204/234/334.

In addition, or alternatively, in some implementations, the method of flowchart 400 may include identifying score 118/218 corresponding to the likelihood of acceptance of transaction proposal 116/216 by the prospective consumer. Identification of score 118/218 may be performed by transaction proposal unit 110/210a/210b/310 of system 102/202/230/330, executed by respective hardware processor 104/204/234/334, and may be based on various factors. Examples of such factors may include the overall market demand for the one or more products included in transaction proposal 116/216 and/or the transactional history the prospective consumer. In some implementations in which score 118/218 is identified, score 118/218 may be stored in system memory 106/206/236/336. However, in other implementations, score 118/218 may be reported to system user 140.

Thus, the transaction proposal generation systems and methods disclosed in the present application can provide a comprehensive tool for searching out, evaluating, proposing, and implementing transactions between the producers or suppliers of a product and consumers of such products. In addition, the transaction proposal generation systems and methods disclosed in the present application can be configured to identify and propose transactions capable of conferring substantial benefits to product producers or suppliers and consumers alike. As a result, the transaction proposal generation solutions disclosed herein can enable producers or suppliers of a product to efficiently identify prospective consumers for that product. According to one implementation, such a system and method may be used to assist producers and/or publishers of media content in demonstrating to advertisers that the content those producers and/or publishers offer provides an effective vehicle for marketing the advertisers' goods or services to a target audience.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A transaction proposal generation system comprising:
a hardware processor and a system memory,
a transaction proposal unit stored in the system memory, the transaction proposal unit including a consumer-to-product matching module and a transaction analysis module;
wherein the hardware processor is configured to execute the transaction proposal unit to:
receive a first data corresponding to a transactional history of each of a first plurality of market participants in a market;
receive a second data corresponding to a demand, by each of the market participants, for each of a second plurality of products on the market;
transform, using the consumer-to-product matching module, the first data and the second data into a third data identifying a prospective consumer for at least one of the products from among the first plurality of market participants;
determine, using the transaction analysis module, terms for a transaction including the prospective consumer and the at least one product; and
generate a transaction proposal identifying the prospective consumer, the at least one product, and the terms.

2. The transaction proposal generation system of claim 1, wherein the hardware processor is further configured to execute the transaction proposal unit to display the transaction proposal to a user of the transaction modeling system.

3. The transaction proposal generation system of claim 2, wherein the hardware processor is further configured to execute the transaction proposal unit to:
receive an input from the user modifying at least one of the prospective consumer, the at least one product, and the terms; and
generate another transaction proposal based on the input from the user.

4. The transaction proposal generation system of claim 1, wherein the transaction comprises purchase of the at least one product by the prospective consumer.

5. The transaction proposal generation system of claim 1, wherein the at least one product comprises advertising time during an entertainment presentation.

6. The transaction proposal generation system of claim 1, wherein the at least one product comprises advertising time in a television (TV) programming stream.

7. The transaction proposal generation system of claim 1, wherein the hardware processor is further configured to execute the transaction proposal unit to identify a score corresponding to a likelihood of acceptance of the transaction proposal by the prospective consumer.

8. The transaction proposal generation system of claim 7, wherein the hardware processor is further configured to execute the transaction proposal unit to at least one of store the score in the system memory and report the score to a user of the transaction modeling system.

9. A method for use by a transaction proposal generation system including a hardware processor and a system memory having a transaction proposal unit stored therein, the method comprising:
receiving a first data corresponding to a transactional history of each of a first plurality of market participants in a market;
receiving a second data corresponding to a demand, by each of the market participants, for each of a second plurality of products on the market;
transforming the first data and the second data into a third data identifying a prospective consumer for at least one of the products from among the first plurality of market participants;
determining terms for a transaction including the prospective consumer and the at least one product; and
generating a transaction proposal identifying the prospective consumer, the at least one product, and the terms.

10. The method of claim 9, further comprising displaying the transaction proposal to a user of the transaction proposal generation system.

11. The method of claim 10, further comprising:
receiving an input from the user modifying at least one of the prospective consumer, the at least one product, and the terms; and
generating another transaction proposal based on the input from the user.

12. The method of claim 9, wherein the transaction comprises purchase of the at least one product by the prospective consumer.

13. The method of claim 9, wherein the at least one product comprises advertising time during an entertainment presentation.

14. The method of claim 9, wherein the at least one product comprises advertising time in a television (TV) programming stream.

15. The method of claim 9, further comprising identifying a score corresponding to a likelihood of acceptance of the transaction proposal by the prospective consumer.

16. The method of claim 15, further comprising at least one of storing the score in the system memory and reporting the score to a user of the transaction proposal generation system.

17. A computer-readable non-transitory medium having stored thereon instructions, which when executed by a hardware processor, instantiate a method comprising:
receiving a first data corresponding to a transactional history of each of a first plurality of market participants in a market;
receiving a second data corresponding to a demand, by each of the market participants, for each of a second plurality of products on the market;
transforming the first data and the second data into a third data identifying a prospective consumer for at least one of the products from among the first plurality of market participants;
determining terms for a transaction including the prospective consumer and the at least one product; and
generating a transaction proposal identifying the prospective consumer, the at least one product, and the terms.

18. The computer-readable non-transitory medium of claim 17, further comprising displaying the transaction proposal to a user of a system including the hardware processor.

19. The computer-readable non-transitory medium of claim 18, further comprising:
receiving an input from the user modifying at least one of the prospective consumer, the at least one product, and the terms; and
generating another transaction proposal based on the input from the user.

20. The computer-readable non-transitory medium of claim 17, further comprising identifying a score corresponding to a likelihood of acceptance of the transaction proposal by the prospective consumer.
